(19) United States
(12) Patent Application Publication
(10) Pub. No.: US 2026/0081233 A1
(43) Pub. Date: Mar. 19, 2026

(54) ELECTRODE ASSEMBLY AND SECONDARY BATTERY INCLUDING THE ELECTRODE ASSEMBLY

(71) Applicant: SAMSUNG SDI CO., LTD., Yongin-si (KR)

(72) Inventors: Hyun Kyu KIM, Suwon-si (KR); Byung Min LEE, Suwon-si (KR); Sang Hun KIM, Suwon-si (KR); Dong Yun HAN, Suwon-si (KR); Su Bin BAE, Suwon-si (KR); Chan Woo ROH, Suwon-si (KR); Beop Gwan JO, Suwon-si (KR)

(21) Appl. No.: 19/312,534

(22) Filed: Aug. 28, 2025

(30) Foreign Application Priority Data
Sep. 13, 2024 (KR) 10-2024-0125749

(51) Int. Cl. H01M 10/0585; H01M 4/02; H01M 4/04; H01M 50/103

(52) U.S. Cl. CPC H01M 10/0585; H01M 4/0435; H01M 2004/021; H01M 2004/027; H01M 2004/028; H01M 50/103

(57) ABSTRACT

The present disclosure relates to an electrode assembly and a secondary battery including the electrode assembly. In an embodiment, the electrode assembly includes a first electrode and a second electrode facing the first electrode in a first direction. A thickness of the first electrode is different from a thickness of the second electrode.

### CROSS-REFERENCE TO RELATED APPLICATION

This application claims priority and benefit under 35 USC § 119 of Korean Patent Application No. 10-2024-0125749, filed on Sep. 13, 2024, in the Korean Intellectual Property Office, the entire disclosure of which is incorporated by reference for all purposes.

### BACKGROUND

### Field

The present disclosure relates to an electrode assembly and a secondary battery including the electrode assembly.

### Description of the Related Art

With the rapid spread of electronic devices that use batteries, such as mobile phones, laptop computers, and electric vehicles, the demand for secondary batteries with high energy density and high capacity has rapidly increased. Accordingly, research and development to improve performance of lithium secondary batteries is being actively conducted.

Lithium secondary batteries are batteries that include a positive electrode and a negative electrode containing active materials capable of intercalation and deintercalation of lithium ions and an electrolyte. The lithium secondary batteries generate electrical energy through oxidation and reduction reactions when lithium ions are intercalated/deintercalated into/from the positive and negative electrodes.

The information disclosed in this section forms the background of the present disclosure, is provided to improve understanding of the background of the present disclosure, and may include information that does not constitute the related art.

### SUMMARY OF THE DISCLOSURE

The present disclosure is directed to providing an electrode assembly capable of reducing a load at a coupling portion between a case and a cap assembly and a secondary battery including the electrode assembly.

These and other aspects and features of the present disclosure will be described in or will be apparent from the following description of embodiments of the present disclosure.

An electrode assembly according to an embodiment of the present disclosure includes a first electrode and a second electrode facing the first electrode in a first direction, wherein a thickness of the first electrode is different from a thickness of the second electrode.

The thickness change amount of the first electrode may be greater than the thickness of the second electrode.

The first electrode may include a negative electrode plate including a first negative electrode part and a second negative electrode part extending from the first negative electrode part in a second direction that intersects the first direction and a negative electrode active material layer with coated on the negative electrode plate.

The first negative electrode part and the second negative electrode part may have different thicknesses.

The thickness of the first negative electrode part may be greater than the thickness of the second negative electrode part.

A length of the first negative electrode part in the second direction and a length of the second negative electrode part in the second direction may be different.

The negative electrode active material layer may include a first negative electrode active material layer coated on the first negative electrode part and a second negative electrode active material layer coated on the second negative electrode part.

The first negative electrode active material layer and the second negative electrode active material layer may have different thicknesses.

The thickness of the first negative electrode active material layer may be greater than the thickness of the second negative electrode active material layer.

The first negative electrode active material layer and the second negative electrode active material layer may be formed by roller pressing with a pressure being applied to the second negative electrode active material layer being greater than a pressure applied to the first negative electrode active material layer.

A length of the first negative electrode active material layer in the second direction and a length of the second negative electrode active material layer in the second direction may be different.

The second electrode may include a positive electrode plate including a first positive electrode part and a second positive electrode part extending from the first positive electrode part in a second direction that intersects the first direction and a positive electrode active material layer coated on the positive electrode plate.

The first positive electrode part and the second positive electrode part may have different thicknesses.

A length of the first positive electrode part in the second direction and a length of the second positive electrode part in the second direction may be different.

The positive electrode active material layer may include a first positive electrode active material layer coated on the first positive electrode part and a second positive electrode active material layer coated on the second positive electrode part.

The first positive electrode active material layer and the second positive electrode active material layer may have different thicknesses.

The first positive electrode active material layer and the second positive electrode active material layer may be formed by roller pressing, with a pressure that is applied to the first positive active material layer being different than a pressure applied to the second positive active material layer.

A length of the first positive electrode active material layer in the second direction and a length of the second positive electrode active material layer in the second direction may be different.

A secondary battery according to an embodiment of the present disclosure includes a case, an electrode assembly accommodated in the case and including a first electrode and a second electrode, and a cap assembly facing the electrode assembly, wherein a thickness of the first electrode is different than a thickness of the second electrode.

### BRIEF DESCRIPTION OF THE DRAWINGS

The above and other objects, features, and advantages of the present disclosure will become more apparent to those of ordinary skill in the art by describing exemplary embodiments thereof in detail with reference to the accompanying drawings, in which:

FIG. 1 is a schematic perspective view of a configuration of a secondary battery according to an embodiment of the present disclosure;

FIG. 2 is an exploded perspective view of FIG. 1;

FIG. 3 is an exploded perspective view of a configuration of an electrode assembly according to an embodiment of the present disclosure when viewed from one direction;

FIG. 4 is an exploded perspective view of the configuration of the electrode assembly of FIG. 3 when viewed from another direction;

FIG. 5 is a schematic cross-sectional view of a configuration of a secondary battery according to a first embodiment of the present disclosure;

FIG. 6 is a schematic exploded view of a configuration of a first electrode according to the first embodiment of the present disclosure;

FIG. 7 is a schematic cross-sectional view of a change in thickness when the secondary battery is charged according to the first embodiment of the present disclosure;

FIG. 8 is a schematic cross-sectional view of a configuration of a secondary battery according to a second embodiment of the present disclosure;

FIG. 9 is a schematic exploded view of a configuration of a first electrode according to the second embodiment of the present disclosure;

FIG. 10 is a schematic cross-sectional view illustrating a state in which the first electrode is being rolled according to the second embodiment of the present disclosure;

FIG. 11 is a schematic cross-sectional view illustrating a change in thickness when the secondary battery is charged according to the second embodiment of the present disclosure;

FIG. 12 is a schematic cross-sectional view of a configuration of a secondary battery according to a third embodiment of the present disclosure;

FIG. 13 is a schematic exploded view of a configuration of a second electrode according to the third embodiment of the present disclosure;

FIG. 14 is a schematic cross-sectional view illustrating a change in thickness when the secondary battery is charged according to the third embodiment of the present disclosure;

FIG. 15 is a schematic cross-sectional view of a configuration of a secondary battery according to a fourth embodiment of the present disclosure;

FIG. 16 is a schematic exploded view of a configuration of a second electrode according to the fourth embodiment of the present disclosure;

FIG. 17 is a schematic cross-sectional view illustrating a state in which the second electrode is being rolled according to the fourth embodiment of the present disclosure;

FIG. 18 is a schematic cross-sectional view illustrating a change in thickness when the secondary battery is charged according to the fourth embodiment of the present disclosure;

FIG. 19 is a schematic cross-sectional view of a configuration of a secondary battery according to a fifth embodiment of the present disclosure;

FIG. 20 is a schematic exploded view of a configuration of a first electrode and a second electrode according to the fifth embodiment of the present disclosure;

FIG. 21 is a schematic cross-sectional view illustrating a change in thickness when the secondary battery is charged according to the fifth embodiment of the present disclosure;

FIG. 22 is a schematic cross-sectional view illustrating a configuration of a secondary battery according to a sixth embodiment of the present disclosure;

FIG. 23 is a schematic exploded view illustrating a configuration of a first electrode and a second electrode according to the sixth embodiment of the present disclosure;

FIG. 24 is a schematic cross-sectional view illustrating a state in which the first electrode and the second electrode are being rolled according to the sixth embodiment of the present disclosure; and

FIG. 25 is a schematic cross-sectional view illustrating a change in thickness when the secondary battery is charged according to the sixth embodiment of the present disclosure.

### DETAILED DESCRIPTION

Embodiments of the present disclosure will be described, in further detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not necessarily represent all of the technical ideas, aspects, and features of the present disclosure. Accordingly, it is to be understood that there may be various equivalents and modifications that may replace or modify the embodiments described herein.

It is to be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections are not to be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Any numerical range disclosed and/or recited herein is intended to include all sub-ranges of the same numerical precision subsumed within the recited range. For example, a range of “1.0 to 10.0” includes all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein includes all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are the same or substantially the same. Thus, the phrase “the same” or “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an element is referred to as being arranged (or located or positioned) on the “above (or below)” or “on (or under)” a component, it may mean that the element is placed in contact with the upper (or lower) surface of the component and may also mean that another component may be interposed between the component and any element arranged (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

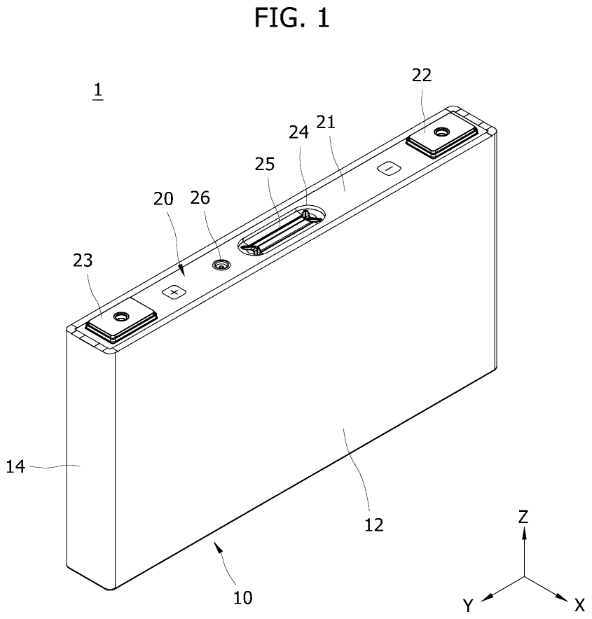

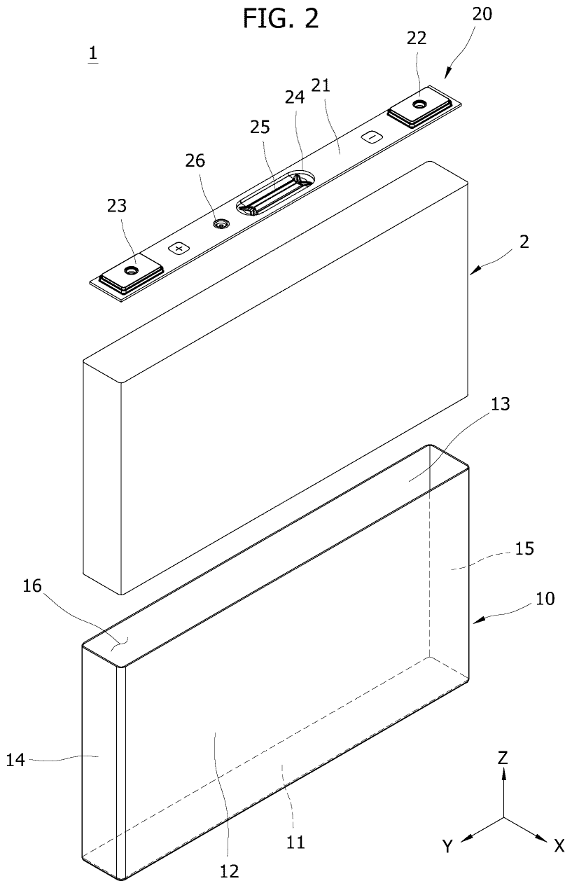

FIG. 1 is a schematic perspective view of a configuration of a secondary battery according to an embodiment of the present disclosure, and FIG. 2 is a schematic exploded perspective view of the configuration of the secondary battery according to the embodiment of the present disclosure.

Referring to FIGS. 1 and 2, a secondary battery 1 according to the present disclosure may function as a unit structure for storing and supplying power from a battery module or a battery pack. Hereinafter, the described secondary battery 1 is a lithium ion secondary battery 1 and may be a prismatic battery. However, the present disclosure is not limited to such types of batteries, and the secondary battery 1 may be a lithium polymer battery or a cylindrical battery.

The secondary battery 1 according to the present disclosure may include a case 10, an electrode assembly 2, and a cap assembly 20. The case 10 may form an exterior of the secondary battery 1 and may accommodate the electrode assembly 2. The case 10 may include a bottom part 11, a front surface part 12, a rear surface part 13, a first side surface part 14, and a second side surface part 15.

The bottom part 11 may form a lower exterior of the case 10 (based on the orientation shown in FIG. 2). The bottom part 11 according to the present disclosure may have a rectangular plate shape.

The front surface part 12, the rear surface part 13, the first side surface part 14, and the second side surface part 15 may form an exterior of a circumferential surface of the case 10.

The front surface part 12, the rear surface part 13, the first side surface part 14, and the second side surface part 15 may have a plate shape extending upward (based on the orientation shown in FIG. 2) from an edge of the bottom part 11.

The front surface part 12, the rear surface part 13, the first side surface part 14, and the second side surface part 15 may be arranged to surround an upper space of the bottom part 11. The front surface part 12, the rear surface part 13, the first side surface part 14, and the second side surface part 15 may be arranged to form a rectangular cross-sectional shape. The front surface part 12 and the rear surface part 13 may be arranged to face each other. The front surface part 12 and the rear surface part 13 may be arranged parallel to each other. And the front surface part 12 and the rear surface part 13 may have the same area.

The first side surface part 14 and the second side surface part 15 may be arranged to face each other. The first side surface part 14 and the second side surface part 15 may be arranged parallel to each other. The first side surface part 14 and the second side surface part 15 may have the same area. The areas of the first side surface part 14 and the second side surface part 15 may be less than the areas of the front surface part 12 and the rear surface part 13.

The case 10 may further include an opening 16. The opening 16 may be a space surrounded by upper ends of the front surface part 12, the rear surface part 13, the first side surface part 14, and the second side surface part 15. The opening 16 may connect an internal space of the case to outside of the case 10. Accordingly, the case 10 according to the present embodiment may have a rectangular shape with an open upper side.

A first direction described below is the direction of the X-axis shown in FIG. 2 and a direction toward the front surface part 12 from the rear surface part 13. A second direction is the direction of the Z-axis as shown in FIG. 2 and toward the opening 16 from the bottom part 11. A third direction is the direction of the Y-axis shown in FIG. 2 and toward the first side surface part 14 from the second side surface part 15.

The electrode assembly 2 may function as a unit structure that performs a charging operation and a discharging operation of electricity in the secondary battery 1. The electrode assembly 2 may be accommodated inside the case 10.

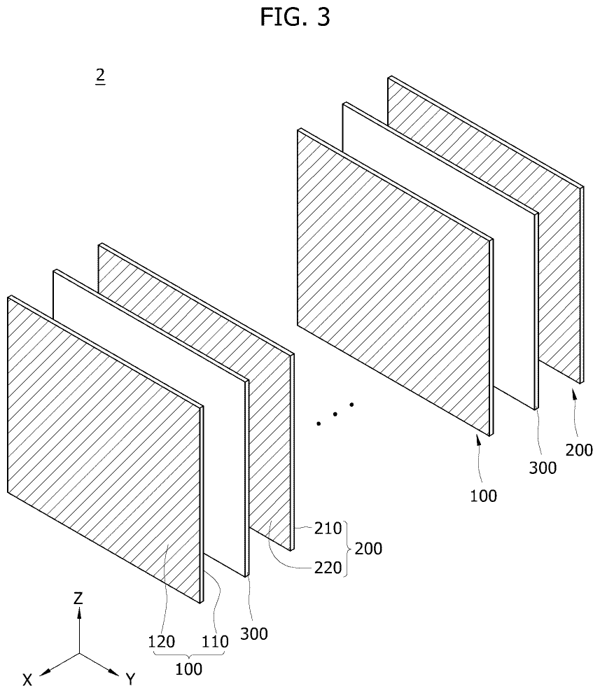

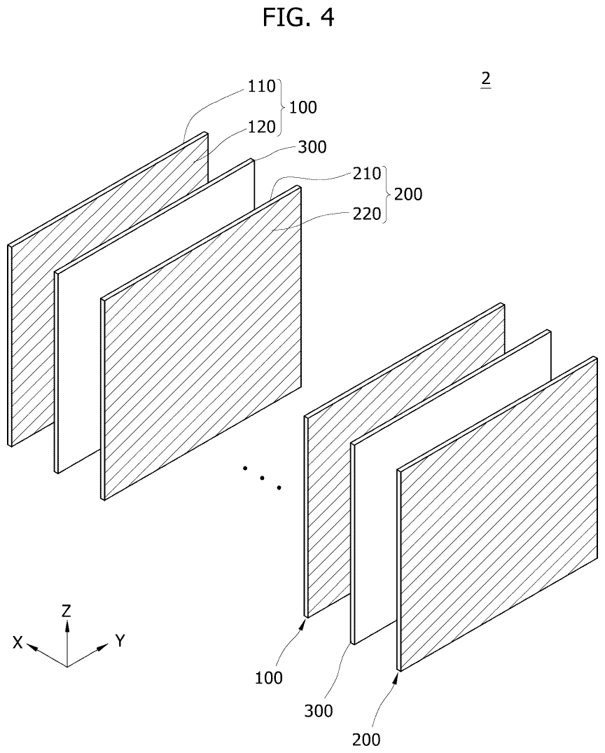

FIG. 3 is an exploded perspective view of a configuration of an electrode assembly according to an embodiment of the present disclosure when viewed from one direction, and FIG. 4 is an exploded perspective view of the configuration of the electrode assembly according to the embodiment of the present disclosure when viewed from another direction.

Referring to FIGS. 1 to 4, the electrode assembly 2 according to the present embodiment may include a first electrode 100, a second electrode 200, and a separator 300 disposed between the first electrode 100 and the second electrode 200. The first electrode 100 may be provided as a plurality of first electrodes 100, the separator 300 may be provided as a plurality of separators 300, and the second electrode 200 may be provided as a plurality of second electrodes 200.

Hereinafter, an electrode assembly 2 having a laminated form will be described in which the plurality of first electrodes 100, the plurality of separators 300, and the plurality of second electrodes 200 are sequentially laminated in the first direction. However, the electrode assembly 2 is not limited to this form and may, for example, have a form in which the first electrode 100, the separator 300, and the second electrode 200 are laminated and are wound clockwise or counterclockwise about a winding axis.

The first electrode 100 may function as a negative electrode or a positive electrode of the electrode assembly 2. Hereinafter, the first electrode 100 will be described as the negative electrode of the electrode assembly 2. However, the first electrode 100 is not limited thereto and may instead function as the positive electrode of the electrode assembly 2.

The first electrode 100 may be provided as a plurality of first electrodes 100. The plurality of first electrodes 100 may be arranged between the front surface part 12 and the rear surface part 13 of the case 10 in the first direction. The number of first electrodes 100 may be vary depending on a charging capacity or the like of the secondary battery 1.

The first electrode 100 according to the present embodiment may include a negative electrode plate 110 and a negative electrode active material layer 120. The negative electrode plate 110 may be formed to have a shape of a foil including a metal material such as copper, a copper alloy, nickel, or a nickel alloy. The type, the size, and the shape of the negative electrode plate 110 are not limited as long as the negative electrode plate 110 is conductive and does not cause a chemical change in the secondary battery 1. A cross-sectional shape of the negative electrode plate 110 may be various shapes other than the rectangular shape illustrated in FIG. 3.

The negative electrode plate 110 may be coated with the negative electrode active material layer 120. Both surfaces of the negative electrode plate 110 may be coated with the negative electrode active material layer 120 or only one surface of the negative electrode plate 110 may be coated with the negative electrode active material layer 120.

In the present embodiment, as the first electrode 100 functions as the negative electrode, the negative electrode active material layer 120 may include a negative electrode active material. The negative electrode active material may include a material capable of reversibly intercalating/deintercalating lithium ions, a lithium metal, an alloy of the lithium metal, a material capable of being doped to and dedoped from lithium, or a transition metal oxide.

The material capable of reversibly intercalating/deintercalating the lithium ions may be a carbon-based negative electrode active material, for example, a crystalline carbon, an amorphous carbon, or a combination thereof. Examples of the crystalline carbon include graphite, such as natural graphite or artificial graphite, in an amorphous form, a plate-like form, a flake-like form, a spherical form, or a fibrous form, and examples of the amorphous carbon include soft carbon, hard carbon, mesophase pitch carbide, calcined coke, etc.

An alloy of lithium and a metal selected from Na, K, Rb, Cs, Fr, Be, Mg, Ca, Sr, Si, Sb, Pb, In, Zn, Ba, Ra, Ge, Al, and Sn may be used as the alloy of the lithium metal.

A Si-based negative electrode active material or a Sn-based negative electrode active material may be used as a material that may be doped to and dedoped from lithium. The Si-based negative electrode active material may be silicon, a silicon-carbon composite, SiOₓ (0<x<2), a Si-Q alloy, or a combination thereof. In the formula Si-Q, Q is selected from an alkali metal, an alkaline earth metal, a group 13 element, a group 14 element (excluding Si), a group 15 element, a group 16 element, a transition metal, a rare earth element, or a combination thereof. The Sn-based negative electrode active material may be Sn, SnO₂, a Sn-based alloy, or a combination thereof.

The silicon-carbon composite may be a composite of silicon and amorphous carbon. The silicon-carbon composite may be in the form of silicon particles and amorphous carbon with which surfaces of the silicon particles are coated. For example, the silicon-carbon composite may include secondary particles (core) assembled with primary silicon particles and an amorphous carbon coating layer (shell) located on surfaces of the secondary particles.

The amorphous carbon may also be located between the primary silicon particles, and, for example, the primary silicon particles may be coated with the amorphous carbon. The secondary particles may be dispersed in an amorphous carbon matrix.

The silicon-carbon composite may further include crystalline carbon. For example, the silicon-carbon composite may include a core including the crystalline carbon and the silicon particles and an amorphous carbon coating layer provided on a surface of the core.

The Si-based negative electrode active material or the Sn-based negative electrode active material may be mixed with the carbon-based negative electrode active material.

The negative electrode active material layer 120 may further include a negative electrode conductive material and a negative electrode binder. The negative electrode conductive material may be used to provide conductivity to the negative electrode active material layer 120 and made of any material that does not cause a chemical change and is electronically conductive. Examples of the negative electrode conductive material include a carbon-based material such as natural graphite, artificial graphite, carbon black, acetylene black, Ketjen black, a carbon fiber, carbon nanofibers, and carbon nanotubes, a metal-based material in the form of metal powder or a metal fiber containing copper, nickel, aluminum, silver, etc., a conductive polymer such as a polyphenylene derivative, or a mixture thereof.

The negative electrode binder serves to attach particles constituting the negative electrode active material to each other and also to attach the negative electrode active material to the negative electrode plate 110. A non-aqueous binder, an aqueous binder, a dry binder, or a combination thereof may be used as an example of the negative electrode binder.

Examples of the non-aqueous binder include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, a fluoroelastomer, a polyethylene oxide, polyvinylpyrrolidone, polyepichlorohydrin, polyphosphazene, poly(meth)acrylonitrile, an ethylene propylene diene copolymer, polyvinyl pyridine, chlorosulfonated polyethylene, latex, polyester resin, (meth)acrylic resin, phenol resin, epoxy resin, polyvinyl alcohol, and a combination thereof.

When the aqueous binder is used as the negative electrode binder, the cellulose-based compound capable of imparting viscosity may included. A mixture of one or more of carboxymethyl cellulose, hydroxypropylmethyl cellulose, methyl cellulose, or an alkali metal salt thereof may be used as the cellulose-based compound. Na, K, or Li may be used as the alkali metal.

The dry binder, which is a polymer material that may be fiberized, may be, for example, polytetrafluoroethylene, polyvinylidene fluoride, a polyvinylidene fluoride-hexafluoropropylene copolymer, a polyethylene oxide, or a combination thereof. The negative electrode plate 110 according to the present disclosure may include a first negative electrode part 111 and a second negative electrode part 112. The first negative electrode part 111 may be disposed in a lower area of the negative electrode plate 110 toward the bottom part 11 of the case 10. The second negative electrode part 112 may extend from the first negative electrode part 111 in the second direction. The second negative electrode part 112 may be disposed in an upper area of the negative electrode plate 110 disposed toward the opening 16 of the case 10.

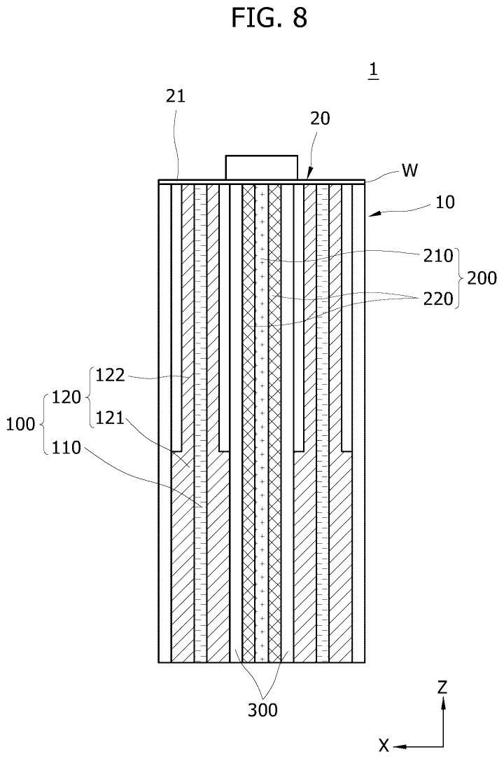

The negative electrode active material layer 120 according to the present disclosure may include a first negative electrode active material layer 121 and a second negative electrode active material layer 122 (see FIG. 8). The first negative electrode part 111 may be coated with the first negative electrode active material layer 121. Both surfaces of the first negative electrode part 111 may be coated with the first negative electrode active material layer 121 or only one surface of the first negative electrode part 111 may be coated with the first negative electrode active material layer 121. The second negative electrode part 112 may be coated with the second negative electrode active material layer 122. Both surfaces of the second negative electrode part 112 may be coated with the second negative electrode active material layer 122, or only one surface of the second negative electrode part 112 may be coated with the second negative electrode active material layer 122.

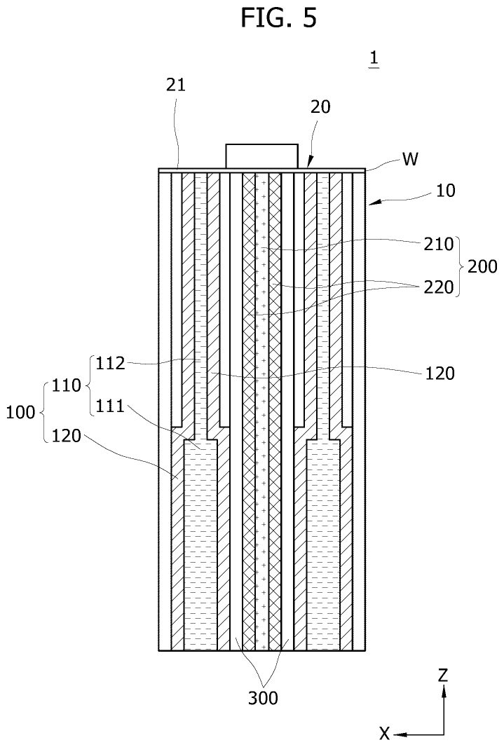

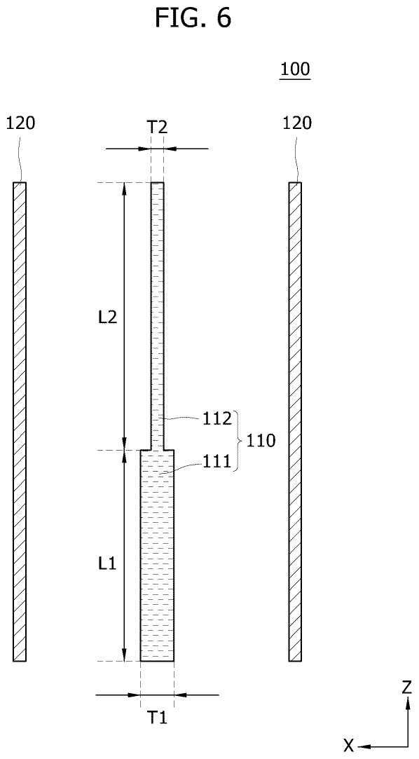

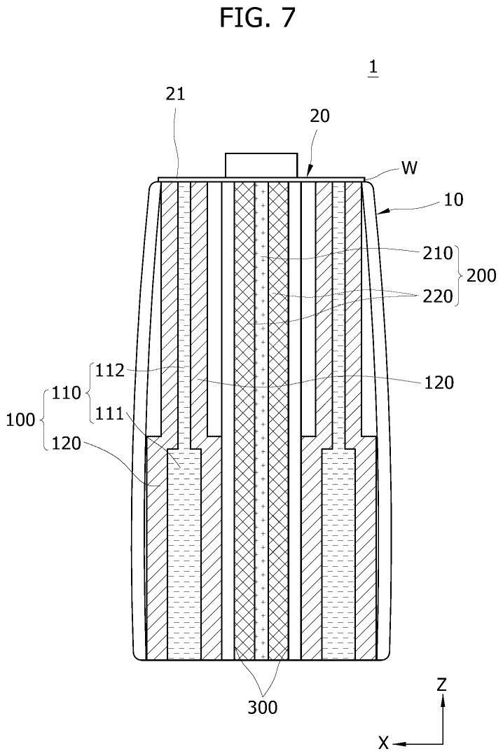

FIG. 5 is a schematic cross-sectional view of a configuration of a secondary battery according to a first embodiment of the present disclosure, FIG. 6 is a schematic exploded view illustrating a configuration of a first electrode according to the first embodiment of the present disclosure, and FIG. 7 is a schematic cross-sectional view illustrating a change in thickness when the secondary battery is charged according to the first embodiment of the present disclosure.

Referring to FIGS. 5 to 7, the electrode assembly 2 according to the first embodiment of the present disclosure may include the first electrode 100 and the second electrode 200. The first electrode 100 may include the negative electrode plate 110 and the negative electrode active material layer 120. The negative electrode plate 110 may include the first negative electrode part 111 and the second negative electrode part 112. The negative electrode active material layer 120 may include the first negative electrode active material layer 121 and the second negative electrode active material layer 122.

The first negative electrode part 111 and the second negative electrode part 112 according to the present embodiment may be formed to have different thicknesses. A thickness T1 of the first negative electrode part 111 may be greater than a thickness T2 of the second negative electrode part 112. In some examples, the thickness T2 of the second negative electrode part 112 may be 50% or more and less than 100% of the thickness T1 of the first negative electrode part 111. A length L1 of the first negative electrode part 111 in the second direction and a length L2 of the second negative electrode part 112 in the second direction may be different from each other. The length L1 of the first negative electrode part 111 may be 20% or more and 80% or less of a length of the entire negative electrode plate 110.

When a secondary battery is charged, it may increase in thickness. Because the thickness T1 of the first negative electrode part 111 is greater than the thickness T2 of the second negative electrode part 112, an increase in thickness of the electrode assembly 2 is concentrated in a lower portion of the secondary battery 1. Thus, a load of an upper portion of the secondary battery 1 where a welded part W is located may be reduced when the secondary battery 1 is charged or discharged. As such, in a configuration according to the present disclosure, a rupture of the welded part W formed between the case 10 and the cap plate 21 may be prevented.

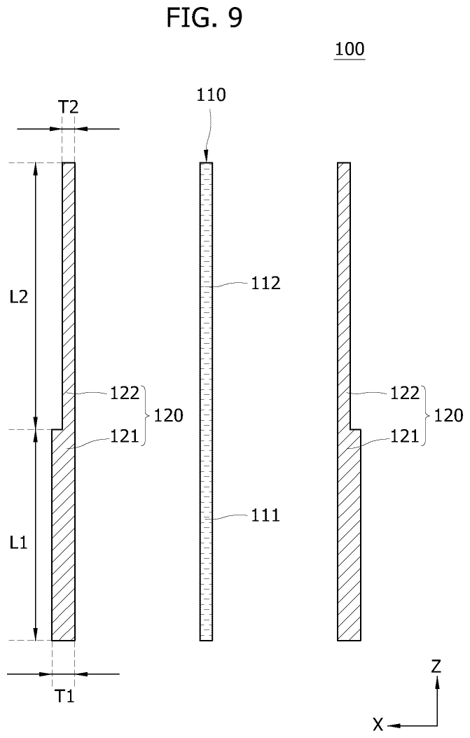

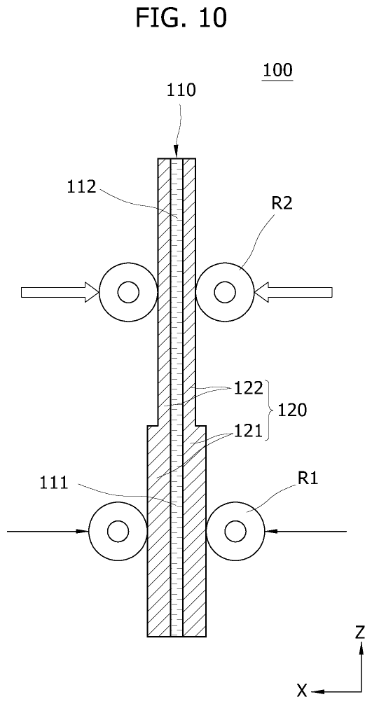

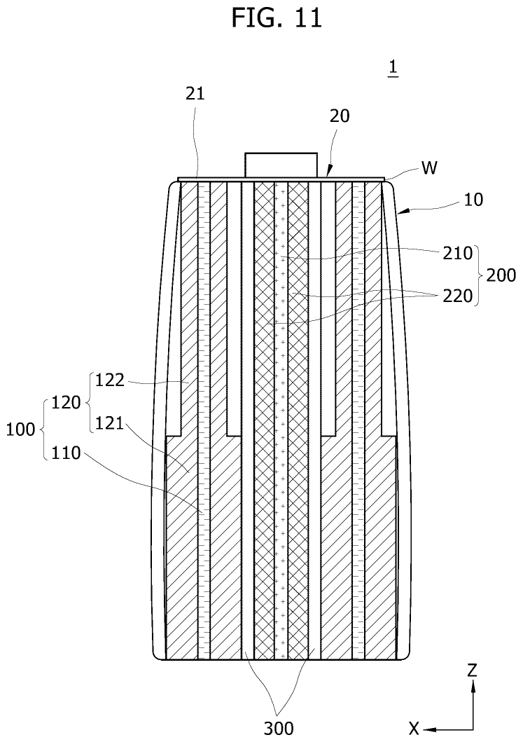

FIG. 8 is a schematic cross-sectional view illustrating a configuration of a secondary battery according to a second embodiment of the present disclosure, FIG. 9 is a schematic exploded view illustrating a configuration of a first electrode according to the second embodiment of the present disclosure, FIG. 10 is a schematic cross-sectional view illustrating a state in which the first electrode is being rolled according to the second embodiment of the present disclosure, and FIG. 11 is a schematic cross-sectional view illustrating a change in thickness when the secondary battery is charged according to the second embodiment of the present disclosure.

Referring to FIGS. 8 to 11, the electrode assembly 2 according to the second embodiment of the present disclosure may include the first electrode 100 and the second electrode 200. The first electrode 100 may include the negative electrode plate 110 and the negative electrode active material layer 120. The negative electrode plate 110 may include the first negative electrode part 111 and the second negative electrode part 112. The negative electrode active material layer 120 may include the first negative electrode active material layer 121 and the second negative electrode active material layer 122.

The first negative electrode active material layer 121 and the second negative electrode active material layer 122 according to the present embodiment have different thicknesses. More specifically, the thickness T1 of the first negative electrode active material layer 121 is greater than the thickness T2 of the second negative electrode active material layer 122. In some examples, the thickness T2 of the second negative electrode active material layer 122 may be 50% or more and less than 100% of the thickness T1 of the first negative electrode active material layer 121.

The second negative electrode active material layer 122 may be formed by roll pressing at a higher pressure than a roll pressing pressure applied to the first negative electrode active material layer 121. As a pressure of a roller R2 that presses the second negative electrode active material layer 122 is greater than a pressure of a roller R1 that presses the first negative electrode active material layer 121, the thickness T2 of the second negative electrode active material 122 becomes less than the thickness T1 of the first negative electrode active material layer 121.

The length L1 of the first negative electrode active material layer 121 in the second direction and the length L2 of the second negative electrode active material layer 122 in the second direction may be different from each other. In some examples, the length L1 of the first negative electrode active material layer 121 may be in a range of 20% to 80% of the length of the entire negative electrode active material layer 120.

As discussed above, when a secondary battery is charged, the battery may become thicker. As the thickness T1 of the first negative electrode active material layer 121 is greater than the thickness T2 of the second negative electrode active material layer 122, an increase in the thickness of the electrode assembly 2 is concentrated in the lower portion of the secondary battery 1. Thus, as previously discussed, the load of the upper portion of the secondary battery 1 at which the welded part W is located, may be reduced when the secondary battery 1 is charged or discharged. As a result, a rupture of the welded part W formed between the case 10 and the cap plate 21 may be prevented.

Referring again to FIGS. 1 to 4, the second electrode 200 according to the present embodiment may function as either the positive electrode or the negative electrode of the electrode assembly 2. Hereinafter, the second electrode 200 will be described as the positive electrode of the electrode assembly 2. However, the second electrode 200 is not limited thereto and may function as the negative electrode of an electrode assembly according to the present disclosure.

The second electrode 200 may be provided as a plurality of second electrodes 200. The plurality of second electrodes 200 may be arranged between the front surface part 12 and the rear surface part 13 of the case 10 in the first direction. The number of second electrodes 200 may varying depending on a charging capacity or the like of the secondary battery 1.

The first electrode 100 and the second electrode 200 may be alternately arranged in the first direction. The second electrode 200 may be spaced a predetermined distance from the first electrode 100 in the first direction.

The second electrode 200 according to the present embodiment may include a positive electrode plate 210 and a positive electrode active material layer 220. The positive electrode plate 210 may be formed to have a shape of a foil including a metal material such as aluminum or an aluminum alloy. The type, size, and shape of the positive electrode plate 210 are not limited as long as the positive electrode plate 210 is conductive and does not cause a chemical change in the secondary battery 1. A cross-sectional shape of the positive electrode plate 210 may be various shapes other than the rectangular shape illustrated in FIG. 3.

The positive electrode plate 210 may be coated with the positive electrode active material layer 220. Both surfaces of the positive electrode plate 210 may be coated with the positive electrode active material layer 220 or one surface of the positive electrode plate 210 may be coated with the positive electrode active material layer 220.

In the present embodiment, as the second electrode 200 functions as the positive electrode, the positive electrode active material layer 220 may include a positive electrode active material. The positive electrode active material may be a compound capable of reversible intercalation and deintercalation of lithium (a lithiated intercalation compound). In more detail, one or more of a composite oxide of a metal selected from cobalt, manganese, nickel, iron, and a combination thereof and lithium may be used as the positive electrode active material.

For example, the positive electrode active material may include at least one of a lithium-iron-phosphorus oxide LFP (LiFePO₄), a lithium-manganese-iron-phosphorus oxide LMFP (LiMnFePO₄) and a lithium-nickel-cobalt-manganese oxide NCM (LiNiₓCo_{y}Mn_{z}O₂). Here, 0<x<1, 0<y<1, 0<z<1, and x+y+z=1 may be satisfied. In some embodiments, the positive electrode active material may include one of the lithium-iron-phosphorus oxide LFP (LiFePO₄), the lithium-manganese-iron-phosphorus oxide LMFP (LiMnFePO₄), and the lithium-nickel-cobalt-manganese oxide NCM (LiNiₓCo_{y}Mn_{z}O₂) or may include two or all of the lithium-iron-phosphorus oxide LFP (LiFePO₄), the lithium-manganese-iron-phosphorus oxide LMFP (LiMnFePO₄), and the lithium-nickel-cobalt-manganese oxide NCM (LiNiₓCo_{y}Mn₂O₂).

The positive electrode active material layer 220 may further include a positive electrode conductive material. The positive electrode conductive material may provide conductivity to the positive electrode active material layer 220 and made of any material that does not cause a chemical change and is electronically conductive. Examples of the positive electrode conductive material may include a carbon-based material such as natural graphite, artificial graphite, carbon black, acetylene black, Ketjen black, a carbon fiber, carbon nanofibers, and carbon nanotubes, a metal-based material in the form of metal powder or a metal fiber containing copper, nickel, aluminum, silver, etc., a conductive polymer such as a polyphenylene derivative, or a mixture thereof.

The positive electrode active material layer 220 may further include a positive electrode binder. The positive electrode binder serves to attach particles constituting the positive electrode active material to each other and also to attach the positive electrode active material to the positive electrode plate 210.

A non-aqueous binder, an aqueous binder, a dry binder, or a combination thereof may be used as an example of the positive electrode binder.

Examples of the non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, a fluoroelastomer, a polyethylene oxide, polyvinylpyrrolidone, polyepichlorohydrin, polyphosphazene, poly(meth)acrylonitrile, an ethylene propylene diene copolymer, polyvinyl pyridine, chlorosulfonated polyethylene, latex, polyester resin, (meth)acrylic resin, phenol resin, epoxy resin, polyvinyl alcohol, and a combination thereof.

When the aqueous binder is used as the positive electrode binder, the cellulose-based compound capable of imparting viscosity may be further included. A mixture of one or more of carboxymethyl cellulose, hydroxypropylmethyl cellulose, methyl cellulose, or an alkali metal salt thereof may be used as the cellulose-based compound. Na, K, or Li may be used as the alkali metal.

The dry binder, which is a polymer material that may be fiberized, may be, for example, polytetrafluoroethylene, polyvinylidene fluoride, a polyvinylidene fluoride-hexafluoropropylene copolymer, a polyethylene oxide, or a combination thereof.

The separator 300 may be disposed between the first electrode 100 and the second electrode 200. The separator 300 may function to prevent a short circuit between the first electrode 100 and the second electrode 200 while allowing movement of lithium ions between the first electrode 100 and the second electrode 200. The separator 300 may surround an entire surface area of the electrode assembly 2. Accordingly, the separator 300 may prevent the first electrode 100 and the second electrode 200 from being directly exposed to outside of the electrode assembly 2.

Polyethylene, polypropylene, polyvinylidene fluoride, or a multi-layer membrane of two or more thereof may be used as the separator 300. In other examples, mixed multi-layer membrane such as a polyethylene/polypropylene two-layer separator, a polyethylene/polypropylene/polyethylene three-layer separator, or a polypropylene/polyethylene/polypropylene three-layer separator may be used as the separator 300.

The separator 300 may include a porous substrate and a coating layer including an organic material, an inorganic material, or a combination thereof located on one surface or both surfaces of the porous substrate. The porous substrate may be a polymer selected from a polyolefin such as polyethylene and polypropylene, a polyester such as polyethylene terephthalate and polybutylene terephthalate, polyacetal, polyamide, polyimide, polycarbonate, polyether ketone, polyarylether ketone, polyetherimide, polyamideimide, polybenzimidazole, polyether sulfone, a polyphenylene oxide, a cyclic olefin copolymer, polyphenylene sulfide, polyethylene naphthalate, glass fiber, Teflon, polytetrafluoroethylene, and a polymer film formed from two or more copolymers or mixtures thereof.

The organic material may include a polyvinylidene fluoride-based polymer or a (meth)acrylic-based polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof. But the present disclosure is not limited to these examples.

The organic material and the inorganic material may be mixed with each other in one coating layer. In other examples, the organic and inorganic materials may be in the form of laminated coating layers, with one of the coating layers including the organic material and the other coating layer including the inorganic material.

The positive electrode plate 210 according to the present embodiment may include a first positive electrode part 211 and a second positive electrode part 212. The first positive electrode part 211 may be disposed in a lower area of the positive electrode plate 210 disposed toward the bottom part 11 of the case 10. The second positive electrode part 212 may extend from the first positive electrode part 211 in the second direction. The second positive electrode part 212 may be disposed in an upper area of the positive electrode plate 210 disposed toward the opening 16 of the case 10.

The positive electrode active material layer 220 according to the present embodiment may include a first positive electrode active material layer 221 and a second positive electrode active material layer 222.

The first positive electrode part 211 may be coated with the first positive electrode active material layer 221. Both surfaces of the first positive electrode part 211 may be coated with the first positive electrode active material layer 221 or one surface of the first positive electrode part 211 may be coated with the first positive electrode active material layer 221.

The second positive electrode part 212 may be coated with the second positive electrode active material layer 222. Both surfaces of the second positive electrode part 212 may be coated with the second positive electrode active material layer 222 or one surface of the second positive electrode part 212 may be coated with the second positive electrode active material layer 222.

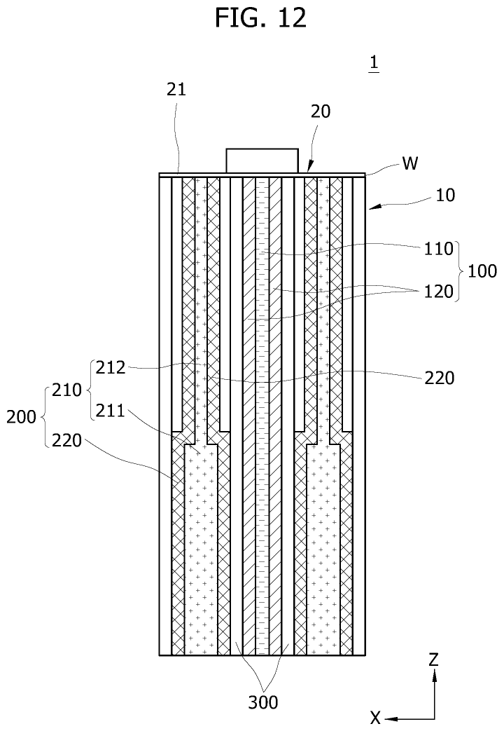

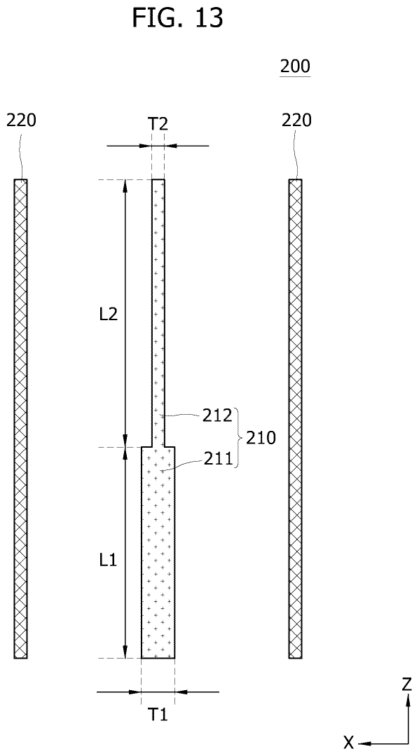

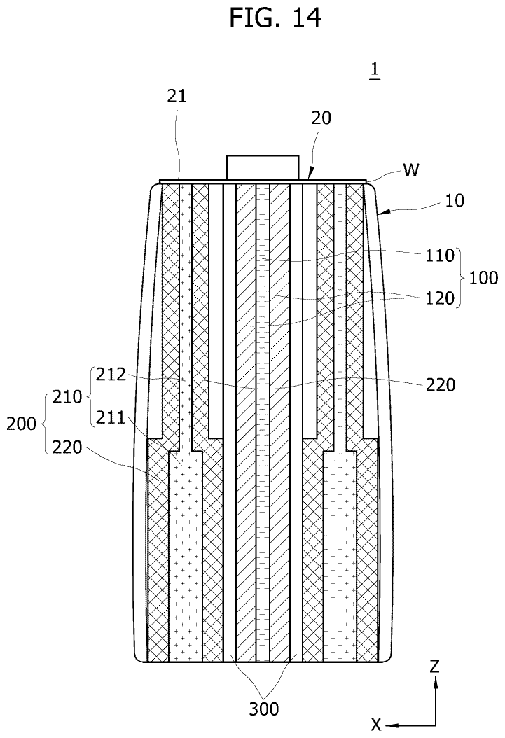

FIG. 12 is a schematic cross-sectional view of a configuration of a secondary battery according to a third embodiment of the present disclosure, FIG. 13 is a schematic exploded view illustrating a configuration of a second electrode according to the third embodiment of the present disclosure, and FIG. 14 is a schematic cross-sectional view illustrating a change in thickness when the secondary battery is charged according to the third embodiment of the present disclosure.

Referring to FIGS. 12 to 14, the electrode assembly 2 according to the third embodiment of the present disclosure may include the first electrode 100 and the second electrode 200. The second electrode 200 may include the positive electrode plate 210 and the positive electrode active material layer 220. The positive electrode plate 210 may include the first positive electrode part 211 and the second positive electrode part 212. The positive electrode active material layer 220 may include the first positive electrode active material layer 221 and the second positive electrode active material layer 222.

The first positive electrode part 211 and the second positive electrode part 212 according to the present embodiment may be formed to have different thicknesses. In some examples, the thickness T1 of the first positive electrode part 211 may be greater than the thickness T2 of the second positive electrode part 212. For example, the thickness T2 of the second positive electrode part 212 may be 50% or more and less than 100% of the thickness T1 of the first positive electrode part 211.

The length L1 of the first positive electrode part 211 in the second direction and the length L2 of the second positive electrode part 212 in the second direction may be different from each other. For example, the length L1 of the first positive electrode part 211 may be 20% or more and 80% or less of the length of the entire positive electrode plate 210.

As previously discussed, when a secondary battery is charged, the battery may become thicker. As the thickness T1 of the first positive electrode part 211 is greater than the thickness T2 of the second positive electrode part 212, an increase in the thickness of the electrode assembly 2, is concentrated in a lower portion of the secondary battery 1. Thus, the load of the upper portion of the secondary battery 1, where the welded part W is located, may be reduced when the secondary battery 1 is charged or discharged. As a result, a rupture of the welded part W formed between the case 10 and the cap plate 21 may be prevented.

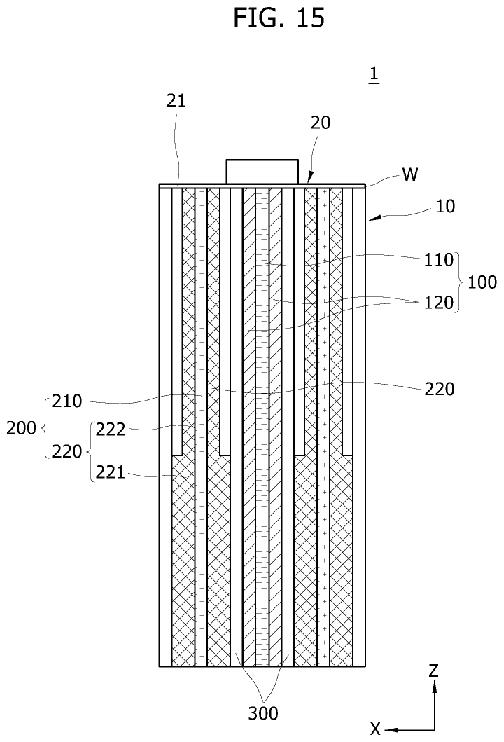

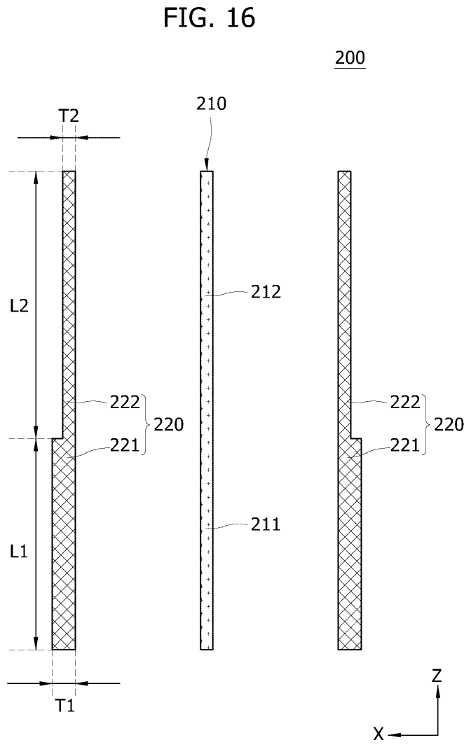

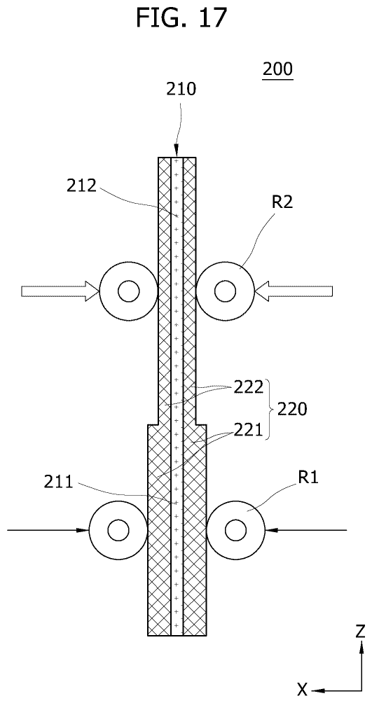

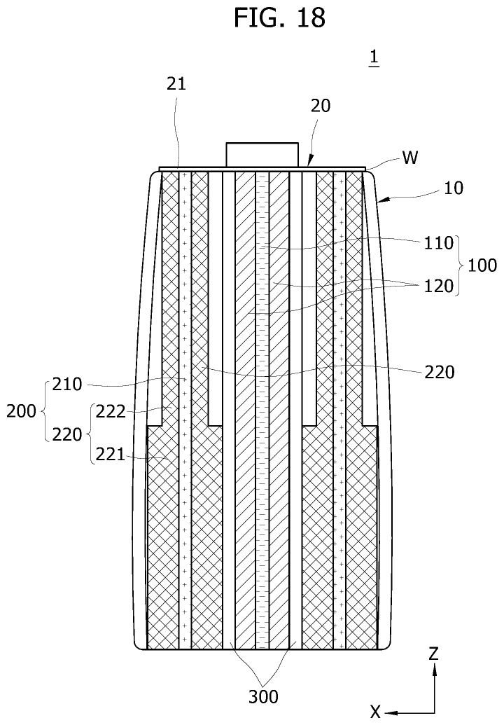

FIG. 15 is a schematic cross-sectional view of a configuration of a secondary battery according to a fourth embodiment of the present disclosure, FIG. 16 is a schematic exploded view of a configuration of a second electrode according to the fourth embodiment of the present disclosure, FIG. 17 is a schematic cross-sectional view of a state in which the second electrode is being rolled according to the fourth embodiment of the present disclosure, and FIG. 18 is a schematic cross-sectional view illustrating a change in thickness when the secondary battery is charged according to the fourth embodiment of the present disclosure.

Referring to FIGS. 15 to 18, the electrode assembly 2 according to the fourth embodiment of the present disclosure may include the first electrode 100 and the second electrode 200. The second electrode 200 may include the positive electrode plate 210 and the positive electrode active material layer 220. The positive electrode plate 210 may include the first positive electrode part 211 and the second positive electrode part 212. The positive electrode active material layer 220 may include the first positive electrode active material layer 221 and the second positive electrode active material layer 222.

The first positive electrode active material layer 221 and the second positive electrode active material layer 222 according to this embodiment may have different thicknesses. In particular, the thickness T1 of the first positive electrode active material layer 221 may be greater than the thickness T2 of the second positive electrode active material layer 222. For example, the thickness T2 of the second positive electrode active material layer 222 may be 50% or more and less than 100% of the thickness T1 of the first positive electrode active material layer 221.

The second positive electrode active material layer 222 may be formed by roll pressing at a higher pressure than roll pressing the first positive electrode active material layer 221. As a pressure of a roller R2 that presses the second positive electrode active material layer 222 is greater than a pressure of the roller R1 that presses the first positive electrode active material layer 221, the thickness T1 of the first positive electrode active material layer 221 relative to the thickness T2 of the second positive electrode active material layer 222 may be increased.

The length L1 of the first positive electrode active material layer 221 in the second direction and the length L2 of the second positive electrode active material layer 222 in the second direction may be different from each other. For example, the length L1 of the first positive electrode active material layer 221 may be in a range of 20% to 80% of the length of the entire positive electrode active material layer 220.

As the thickness T1 of the first positive electrode active material layer 221 is greater than the thickness T2 of the second positive electrode active material layer 222, an increase in the thickness of the electrode assembly 2 is concentrated in the lower portion of the secondary battery 1. Thus, the load of the upper portion of the secondary battery 1 where the welded part W is located may be reduced when the secondary battery 1 is charged or discharged, which may prevent a rupture of the welded part W.

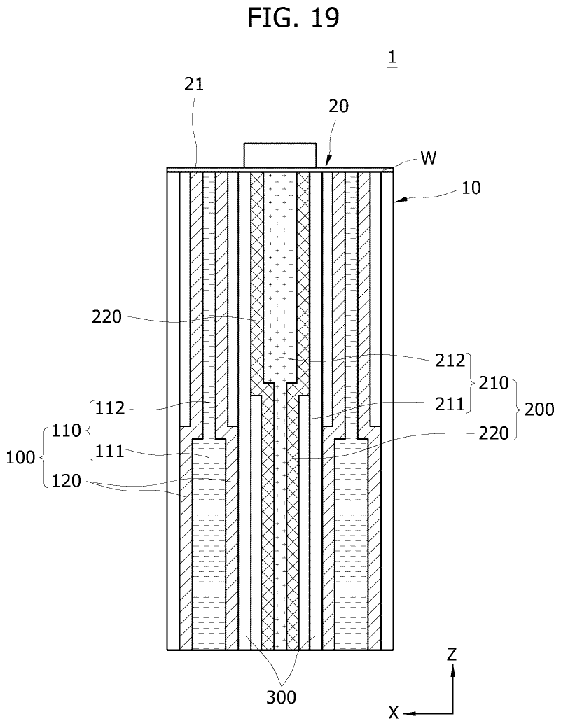

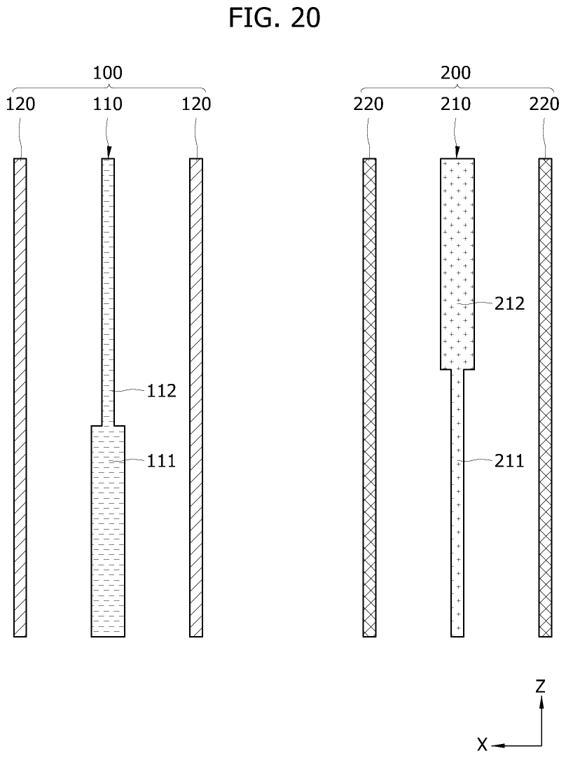

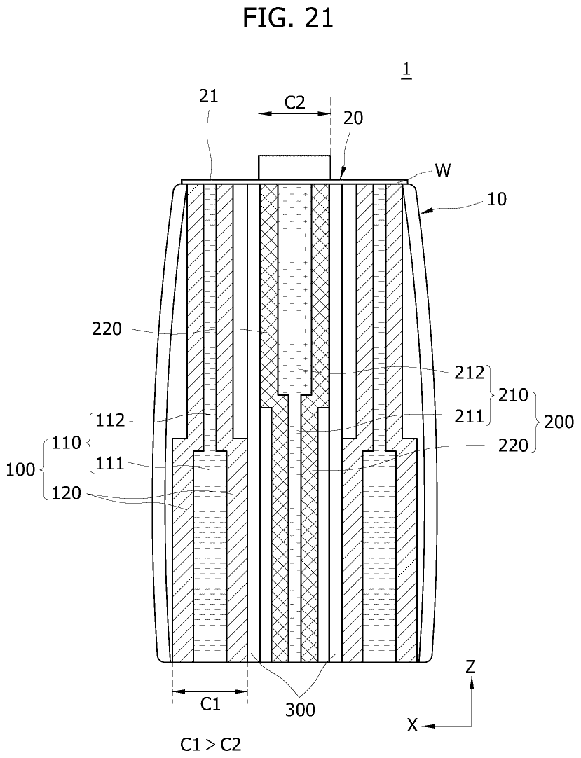

FIG. 19 is a schematic cross-sectional view of a configuration of a secondary battery according to a fifth embodiment of the present disclosure, FIG. 20 is a schematic exploded view of a configuration of a first electrode and a second electrode according to the fifth embodiment of the present disclosure, and FIG. 21 is a schematic cross-sectional view of a change in thickness when the secondary battery is charged according to the fifth embodiment of the present disclosure.

Referring to FIGS. 19 to 21, the electrode assembly 2 according to the fifth embodiment of the present disclosure may include the first electrode 100 and the second electrode 200. The first electrode 100 may include the negative electrode plate 110 and the negative electrode active material layer 120. The negative electrode plate 110 may include the first negative electrode part 111 and the second negative electrode part 112. The negative electrode active material layer 120 may include the first negative electrode active material layer 121 and the second negative electrode active material layer 122. The first negative electrode part 111 and the second negative electrode part 112 may be formed to have different thicknesses. More specifically, the thickness of the first negative electrode part 111 may be greater than the thickness of the second negative electrode part 112.

The second electrode 200 may include the positive electrode plate 210 and the positive electrode active material layer 220. The positive electrode plate 210 may include the first positive electrode part 211 and the second positive electrode part 212. The positive electrode active material layer 220 may include the first positive electrode active material layer 221 and the second positive electrode active material layer 222. The first positive electrode part 211 and the second positive electrode part 212 may be formed to have different thicknesses. More specifically, the thickness of the second positive electrode part 212 may be greater than the thickness of the first positive electrode part 211.

According to the present embodiment, a thickness change amount C1 of the first electrode 100 may be different from a thickness change amount C2 of the second electrode 200. For example, as shown in FIG. 21, when the secondary battery 1 is charged or discharged, the thickness change amount C1 of the first electrode 100 may be greater than the thickness change amount C2 of the second electrode 200.

Even when the thickness of the first negative electrode part 111 is greater than the thickness of the second negative electrode part 112, and the thickness of the second positive electrode part 212 is greater than the thickness of the first positive electrode part 211, since the thickness change amount C1 of the first electrode 100 is greater than the thickness change amount C2 of the second electrode 200, an increase in the thickness of the electrode assembly 2, is concentrated on the lower portion of the secondary battery 1. Thus the load of the upper portion of the secondary battery 1 where the welding part W is located may be reduced when the secondary battery 1 is charged or discharged, which may prevent a rupture of the welded part W.

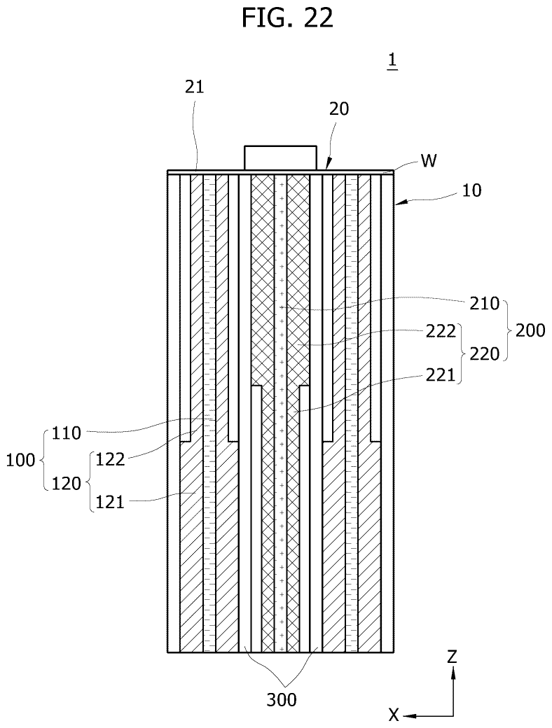

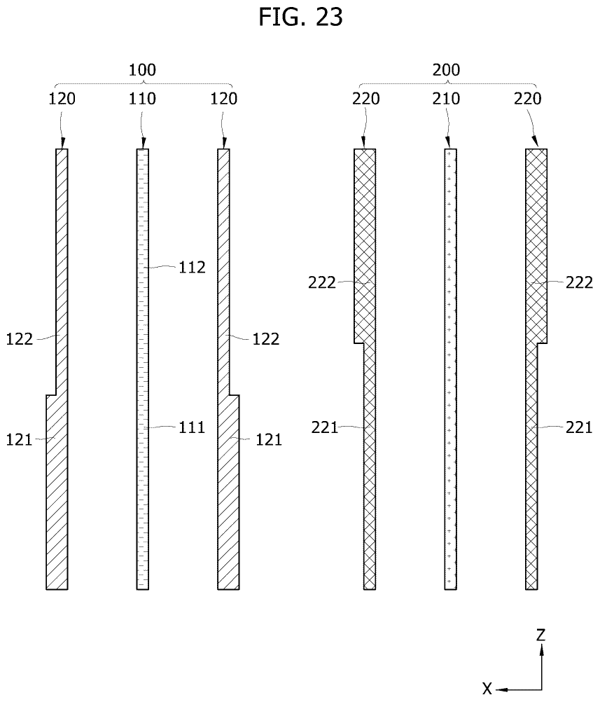

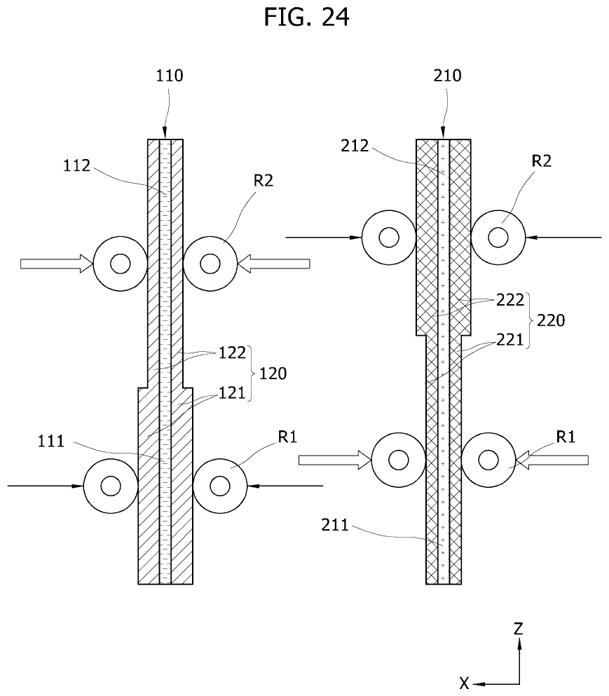

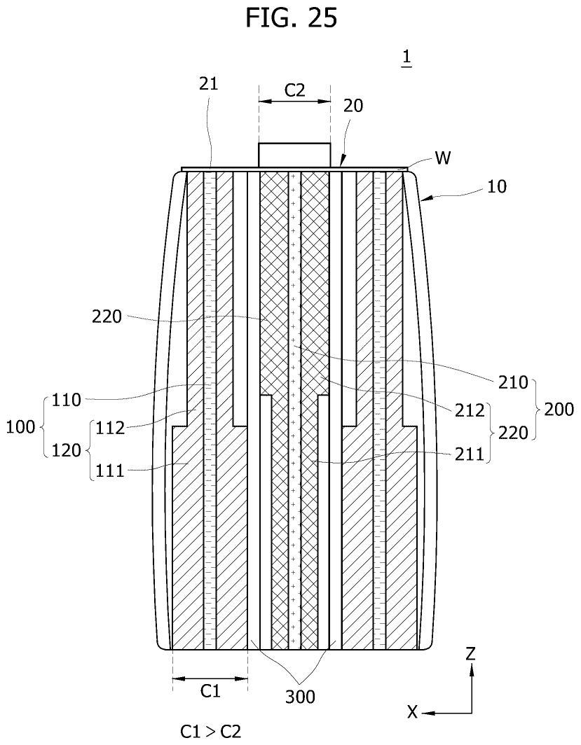

FIG. 22 is a schematic cross-sectional view of a configuration of a secondary battery according to a sixth embodiment of the present disclosure, FIG. 23 is a schematic exploded view of a configuration of a first electrode and a second electrode according to the sixth embodiment of the present disclosure, FIG. 24 is a schematic cross-sectional view of a state in which the first electrode and the second electrode are being rolled according to the sixth embodiment of the present disclosure, and FIG. 25 is a schematic cross-sectional view illustrating a change in thickness when the secondary battery is charged according to the sixth embodiment of the present disclosure.

Referring to FIGS. 22 to 25, the electrode assembly 2 according to the sixth embodiment of the present disclosure may include the first electrode 100 and the second electrode 200. The first electrode 100 may include the negative electrode plate 110 and the negative electrode active material layer 120. The negative electrode plate 110 may include the first negative electrode part 111 and the second negative electrode part 112. The negative electrode active material layer 120 may include the first negative electrode active material layer 121 and the second negative electrode active material layer 122.

The first negative electrode active material layer 121 and the second negative electrode active material layer 122 according to the present embodiment may have different thicknesses. In particular, the thickness of the first negative electrode active material layer 121 may be greater than the thickness of the second negative electrode active material layer 122.

The second negative electrode active material layer 122 may be formed by roll pressing at a higher pressure than the roll pressing pressure of the first negative electrode active material layer 121. As a pressure of the rolling roll R2 that presses the second negative electrode active material layer 122 is greater than a pressure of the rolling roll R1 that presses the first negative electrode active material layer 121, the thickness of the first negative electrode active material layer 121 may become greater than the thickness of the second negative electrode active material layer 122.

The second electrode 200 may include the positive electrode plate 210 and the positive electrode active material layer 220. The positive electrode plate 210 may include the first positive electrode part 211 and the second positive electrode part 212. The positive electrode active material layer 220 may include the first positive electrode active material layer 221 and the second positive electrode active material layer 222.

The first positive electrode active material layer 221 and the second positive electrode active material layer 222 according to the present embodiment may have different thicknesses. In particular, the thickness of the second positive electrode active material layer 222 may be greater than the thickness of the first positive electrode active material layer 221.

The first positive electrode active material layer 221 may be formed by roll pressing at a higher pressure than the roll pressing pressure of the second positive electrode active material layer 222. As a pressure of the rolling roll R1 that presses the first positive electrode active material layer 221 is greater than a pressure of the rolling roll R2 that presses the second positive electrode active material layer 222, the thickness of the second positive electrode active material layer 222 may become greater than the thickness of the first positive electrode active material layer 221.

Even when the thickness of the first negative electrode active material layer 121 is greater than the thickness of the second negative electrode active material layer 122, and the thickness of the second positive electrode active material layer 222 is greater than the thickness of the first positive electrode active material layer 221, since the thickness change amount C1 of the first electrode 100 is greater than the thickness change amount C2 of the second electrode 200 when the secondary battery 1 is charged or discharged, an increase of the thickness of the electrode assembly 2 is concentrated on the lower portion of the secondary battery 1. Thus, the load of the upper portion of the secondary battery 1 where the welded part W is located may be reduced when the secondary battery 1 is charged or discharged. As a result, a rupture of the welded part W formed between the case 10 and the cap plate 21 may be prevented.

Referring again to FIGS. 1 to 4, the cap assembly 20 according to the present embodiment may be coupled to the case 10 and may seal the case 10. The cap assembly 20 may be disposed to face the electrode assembly 2 in the second direction. The cap assembly 20 may include a cap plate 21, a first terminal 22, and a second terminal 23.

The cap plate 21 may form an exterior of the cap assembly 20 and support the first terminal 22 and the second terminal 23 in their entirety. The cap plate 21 according to the present disclosure may be formed as a flat plate. The cap plate 21 may be disposed on the opening 16 of the case 10, and the cap plate 21 may be disposed to face the electrode assembly 2 in the second direction. The cap plate 21 may be disposed at a position spaced a set distance from the electrode assembly 2 in the second direction. The cap plate 21 may be disposed parallel to the bottom part 11 of the case 10.

The cap plate 21 may be seated on an upper end part of the case 10, more specifically, the upper ends of the front surface part 12, the rear surface part 13, the first side surface part 14, and the second side surface part 15. The cap plate 21 may be coupled to the case 10 by welding. The welded part W may be formed between the case 10 and the cap plate 21.

The first terminal 22 may protrude outward from the cap plate 21. The first terminal 22 may be electrically connected to the first electrode 100. As the first electrode 100 according to the present disclosure functions as a negative electrode, the first terminal 22 may be exemplified as a negative electrode terminal of the secondary battery 1.

The first terminal 22 according to the present disclosure may be inserted into the cap plate 21. An upper end of the first terminal 22 may protrude from the cap plate 21 in the second direction.

FIG. 2 depicts the first terminal 22 as having a quadrangular cross-sectional shape, but the cross-sectional shape of the first terminal 22 is not limited thereto. The shape of the first terminal 22 may vary and be, for example, a circular, oval, or a polygonal. The first terminal 22 may be formed of an electrically conductive material such as aluminum, nickel, or copper.

The second terminal 23 may protrude outward from the cap plate 21 at a position spaced apart from the first terminal 22. The second terminal 23 may be electrically connected to the second electrode 200. As the second electrode 200 according to the present disclosure functions as a positive electrode, the second terminal 23 is a positive electrode terminal of the secondary battery 1.

The second terminal 23 according to the present embodiment may be inserted into the cap plate 21. An upper end of the second terminal 23 may protrude from the cap plate 21 in the second direction.

FIG. 2 depicts the second terminal 23 as having a quadrangular cross-sectional shape. But the cross-sectional shape of the second terminal 23 is not limited to the depicted embodiment, and the second terminal 23 may be variously shaped, such as circular shaped, oval shaped, or polygonal shaped. The second terminal 23 may be formed of an electrically conductive material such as aluminum, nickel, or copper.

The second terminal 23 may be disposed at a position spaced a set distance away from the first terminal 22 in the third direction.

The cap assembly 20 according to the present embodiment may further include a vent hole 24 and a vent 25. The vent hole 24 may be formed to vertically pass through the cap plate 21 in the second direction. The vent hole 24 may function to provide a path through which flames, gas, smoke, etc. formed inside the case 10 are discharged to outside of the case 10, which may occur, for example, during thermal runaway of the secondary battery 1 due to overcurrent.

The vent hole 24 may be disposed between the first terminal 22 and the second terminal 23. A cross-sectional shape of the vent hole 24 may be designed to have various shapes such as an oval shape, a circular shape, and a polygonal shape.

The vent 25 may be provided in the vent hole 24 and opened or closed as a result of a change in an internal pressure of the case 10. That is, the vent 25 may close the vent hole 24 during a normal operation of the secondary battery 1 to prevent an electrolyte or the like inside the case 10 from leaking out of the case 10 or to prevent moisture, foreign substances, etc. from being introduced into the case 10. The vent 25 may open, for example, during the thermal runaway of the secondary battery 1 to allow flames, gas, smoke, and the like formed inside the case 10 to be discharged to the outside of the case 10.

The vent 25 may be approximately plate shaped. The vent 25 may be fixed to the cap plate 21 by various types of coupling methods such as welding, bolting, and press-fitting. The vent 25 may be disposed inside the vent hole 24 or may be disposed to face the vent hole 24 in the second direction on an upper side or a lower side of the cap plate 21.

A thickness of the vent 25 in the second direction may be less than a thickness of the cap plate 21. Accordingly, the vent 25 may easily burst or break when the internal pressure of the case 10 increases. The vent 25 may include a notch concavely formed inside the vent 25 such that the vent 25 preferentially breaks when the internal pressure of the case 10 increases.

The cap assembly 20 according to the present embodiment may further include an electrolyte injection port 26, which may be formed through the cap plate 21 and be equipped with a sealing cap. The electrolyte injection port 26 may be disposed between the first terminal 22 and the second terminal 23.

According to embodiments of the present disclosure, when a battery is charged and becomes thicker, the increase in thickness can be concentrated at a lower portion of the secondary battery. Thus, a load on an upper portion of the secondary battery, in which a welded part is located, can be reduced when the secondary battery is charged or discharged. A rupture of the welded part formed between a case and a cap plate may thereby be prevented.

However, the effects obtainable through the present disclosure are not limited to the effects described herein, and other technical effects that are not mentioned will be clearly understood by those skilled in the art.

While the present disclosure has been described with reference to some example embodiments shown in the drawings, these embodiments are merely illustrative and it is to be understood that various modifications and equivalent other embodiments can be derived by those skilled in the art on the basis of the embodiments.

What is claimed is:

1. An electrode assembly comprising:
a first electrode; and
a second electrode facing the first electrode in a first direction,
wherein a thickness of the first electrode is different than a thickness of the second electrode.

2. The electrode assembly of claim 1, wherein the thickness of the first electrode is greater than the thickness of the second electrode.

3. The electrode assembly of claim 1, wherein the first electrode includes:
a negative electrode plate including a first negative electrode part and a second negative electrode part extending from the first negative electrode part in a second direction that intersects the first direction; and
a negative electrode active material layer coated on the negative electrode plate.

4. The electrode assembly of claim 3, wherein the first negative electrode part and the second negative electrode part have different thicknesses.

5. The electrode assembly of claim 4, wherein the thickness of the first negative electrode part is greater than the thickness of the second negative electrode part.

6. The electrode assembly of claim 3, wherein a length of the first negative electrode part in the second direction and a length of the second negative electrode part in the second direction are different.

7. The electrode assembly of claim 3, wherein the negative electrode active material layer includes:
a first negative electrode active material layer coated on the first negative electrode part; and
a second negative electrode active material layer coated on the second negative electrode part.

8. The electrode assembly of claim 7, wherein the first negative electrode active material layer and the second negative electrode active material layer have different thicknesses.

9. The electrode assembly of claim 8, wherein the thickness of the first negative electrode active material layer is greater than the thickness of the second negative electrode active material layer.

10. The electrode assembly of claim 9, wherein the first negative electrode active material layer and the second negative electrode active material layer are formed by roller pressing with a pressure being applied to the second negative electrode active material layer being greater than a pressure applied to the first negative electrode active material layer.

11. The electrode assembly of claim 8, wherein a length of the first negative electrode active material layer in the second direction and a length of the second negative electrode active material layer in the second direction are different.

12. The electrode assembly of claim 1, wherein the second electrode includes:
a positive electrode plate including a first positive electrode part and a second positive electrode part extending from the first positive electrode part in a second direction that intersects the first direction; and
a positive electrode active material layer coated on the positive electrode plate.

13. The electrode assembly of claim 12, wherein the first positive electrode part and the second positive electrode part have different thicknesses.

14. The electrode assembly of claim 12, wherein a length of the first positive electrode part in the second direction and a length of the second positive electrode part in the second direction are different from each other.

15. The electrode assembly of claim 12, wherein the positive electrode active material layer includes:
a first positive electrode active material layer coated on the first positive electrode part; and
a second positive electrode active material layer coated on the second positive electrode part.

16. The electrode assembly of claim 15, wherein the first positive electrode active material layer and the second positive electrode active material layer have different thicknesses.

17. The electrode assembly of claim 16, wherein the first positive electrode active material layer and the second positive electrode active material layer are formed by roller pressing, with a pressure that is applied to the first positive active material layer being different than a pressure applied to the second positive active material layer.

18. The electrode assembly of claim 15, wherein a length of the first positive electrode active material layer in the second direction and a length of the second positive electrode active material layer in the second direction are different.

19. A secondary battery comprising:
a case;
an electrode assembly accommodated in the case and including a first electrode and a second electrode; and
a cap assembly facing the electrode assembly,
wherein a thickness of the first electrode is different than a thickness of the second electrode.

20. A second battery of claim 19, wherein the first electrode includes a first part and a second part having different thicknesses, and
wherein the second electrode includes a first part and a second part having different thicknesses.
